(19) United States
(12) Patent Application Publication
(10) Pub. No.: US 2008/0137371 A1
(43) Pub. Date: Jun. 12, 2008

(54) Optical plate having three layers and backlight module with same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/787,069

(22) Filed: Apr. 13, 2007

(30) Foreign Application Priority Data
Dec. 8, 2006 (CN) 200610201252.6

(51) Int. Cl. F21V 8/00; G02B 5/02

(52) U.S. Cl. 362/613; 359/599

(57) ABSTRACT

An exemplary optical plate includes a first transparent layer, a second transparent layer and a light diffusion layer between the first and second transparent layers. The above-described three layers are integrally formed, with the first transparent layer in immediate contact with the light diffusion layer, and the second transparent layer in immediate contact with the light diffusion layer. The first transparent layer defines micro depressions protruding from an outer surface thereof. Each micro depression has at least three side surfaces connected to each other, and a transverse width of each side surface increases along a direction away from the light diffusion layer. The second transparent layer defines conical frustum protrusions at an outer surface thereof.

### CROSS-REFERENCE TO RELATED APPLICATIONS

This application is related to fourteen copending U.S. patent applications, which are: application Ser. No. 11/620,951 filed on Jan. 8, 2007, and entitled “OPTICAL PLATE HAVING THREE LAYERS”; application Ser. No. 11/620,958, filed on Jan. 8, 2007, and entitled “OPTICAL PLATE HAVING THREE LAYERS AND MICRO PROTRUSIONS”; application Ser. No. 11/623,302, filed on Jan. 5, 2007, and entitled “OPTICAL PLATE HAVING THREE LAYERS”; application Ser. No. 11/623,303, filed on Jan. 15, 2007, and entitled “OPTICAL PLATE HAVING THREE LAYERS AND BACKLIGHT MODULE WITH SAME”; application Ser. No. 11/627,579, filed on Jan. 26, 2007, and entitled “OPTICAL PLATE HAVING THREE LAYERS”; application Ser. No. 11/672,359, filed on Feb. 7, 2007, and entitled “OPTICAL PLATE HAVING THREE LAYERS AND BACKLIGHT MODULE WITH SAME”; application Ser. No. 11/716,323, filed on Mar. 9, 2007, and entitled “OPTICAL PLATE HAVING THREE LAYERS AND BACKLIGHT MODULE WITH SAME”; application Ser. No. 11/716,140, filed on Mar. 9, 2007, and entitled “THREE-LAYERED OPTICAL PLATE AND BACKLIGHT MODULE WITH SAME”; application Ser. No. 11/716,158, filed on Mar. 9, 2007, and entitled “OPTICAL PLATE HAVING THREE LAYERS AND BACKLIGHT MODULE WITH SAME”; application Ser. No. 11/716,143, filed on Mar. 9, 2007, and entitled “OPTICAL PLATE HAVING THREE LAYERS AND BACKLIGHT MODULE WITH SAME”; and application Ser. No. 11/716,141, filed on Mar. 9, 2007, and entitled “OPTICAL PLATE HAVING THREE LAYERS AND BACKLIGHT MODULE WITH SAME”; application serial no. [to be advised], Attorney Docket No. US12890, and entitled “OPTICAL PLATE HAVING THREE LAYERS AND BACKLIGHT MODULE WITH SAME”; application serial no. [to be advised], Attorney Docket No. US12891, and entitled “OPTICAL PLATE HAVING THREE LAYERS AND BACKLIGHT MODULE WITH SAME”; and application serial no. [to be advised], Attorney Docket No. US12897, and entitled “OPTICAL PLATE HAVING THREE LAYERS AND BACKLIGHT MODULE WITH SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot emit light by itself. Rather, the liquid crystal relies on receiving light from a light source in order to display data and images. In the case of a typical LCD panel, a backlight module powered by electricity supplies the needed light.

FIG. 11 is a partly exploded, side cross-sectional view of a typical direct type backlight module 10 employing a typical optical diffusion plate. The backlight module 10 includes a housing 11, a plurality of lamps 12 disposed above a base of the housing 11 for emitting light rays, and a light diffusion plate 13 and a prism sheet 15 stacked on top of the housing 11 in that order. Inside walls of the housing 11 are configured for reflecting certain of the light rays upwards. The light diffusion plate 13 includes a plurality of dispersion particles therein. The dispersion particles are configured for scattering the light rays, and thereby enhancing the uniformity of light output from the light diffusion plate 13. This can correct what might otherwise be a narrow viewing angle experienced by a user of a corresponding LCD panel (not shown). The prism sheet 15 includes a plurality of V-shaped structures at a top thereof.

In use, the light rays from the lamps 12 enter the prism sheet 15 after being scattered in the light diffusion plate 13. The light rays are refracted and concentrated by the V-shaped structures of the prism sheet 15 so as to increase brightness of light illumination, and finally propagate into the LCD panel (not shown) disposed above the prism sheet 15. The brightness may be improved by the V-shaped structures, but the viewing angle may be narrowed. In addition, even though the light diffusion plate 13 and the prism sheet 15 abut each other, a plurality of air pockets still exists at the boundary between them. When the backlight module 10 is in use, light passes through the air pockets, and some of the light undergoes total reflection at one or another of the interfaces at the air pockets. As a result, the light energy utilization ratio of the backlight module 10 is reduced.

Therefore, a new optical means is desired in order to overcome the above-described shortcomings.

### SUMMARY

In one aspect, an optical plate includes a first transparent layer, a second transparent layer, and a light diffusion layer between the first and second transparent layers. The light diffusion layer includes a transparent matrix resin and a plurality of diffusion particles dispersed in the transparent matrix resin. The first transparent layer, the light diffusion layer, and the second transparent layer are integrally formed, with the first transparent layer in immediate contact with the light diffusion layer, and the second transparent layer in immediate contact with the light diffusion layer. The first transparent layer defines a plurality of conical frustum protrusions at outer surface thereof that is farthest from the second transparent layer. The second transparent layer defines a plurality of micro depressions at an outer surface thereof that is farthest from the first transparent layer. Each micro depression has at least three side surfaces connected to each other, and a transverse width of each side surface increases along a direction away from the light diffusion layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a top plan view of the optical plate of FIG. 1.

FIG. 3 is a bottom plan view of the optical plate of FIG. 1.

FIG. 4 is a side, cross-sectional view of the optical plate of FIG. 1, taken along line IV-IV thereof.

FIG. 5 is a side, cross-sectional view of the optical plate of FIG. 1, taken along line V-V thereof.

FIG. 6 is a side, cross-sectional view of a direct type backlight module in accordance with a second embodiment of the present invention, the backlight module including the optical plate shown in FIG. 4.

FIG. 7 is an isometric view of an optical plate in accordance with a third embodiment of the present invention.

FIG. 8 is an isometric view of an optical plate in accordance with a fourth embodiment of the present invention.

FIG. 9 is an isometric view of an optical plate in accordance with a fifth embodiment of the present invention.

FIG. 10 is a side, cross-sectional view of an optical plate in accordance with a sixth embodiment of the present invention.

FIG. 11 is a partly exploded, side cross-sectional view of a conventional backlight module having a prism sheet and a light diffusion plate.

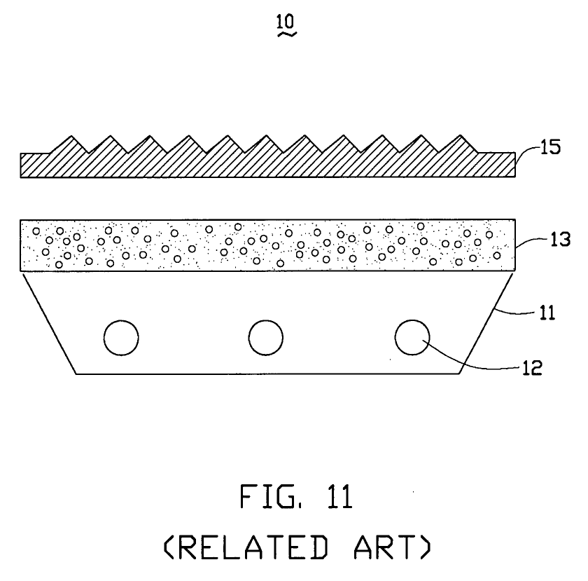

### DETAILED DESCRIPTION OF THE EMBODIMENTS

Reference will now be made to the drawings to describe preferred embodiments of the present optical plate and backlight module, in detail.

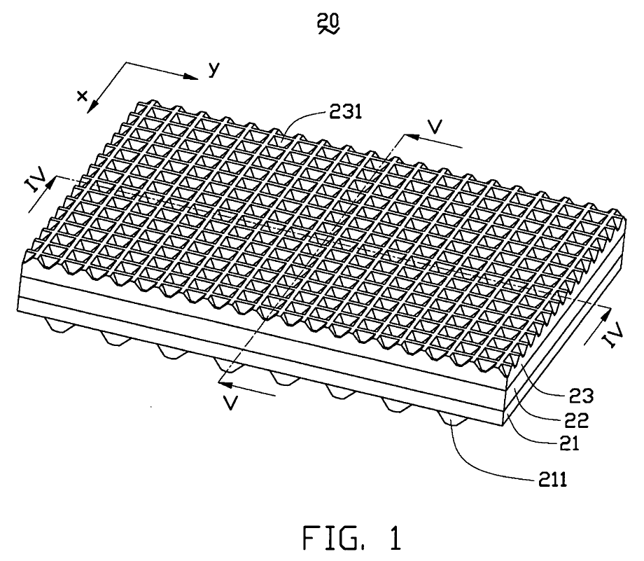

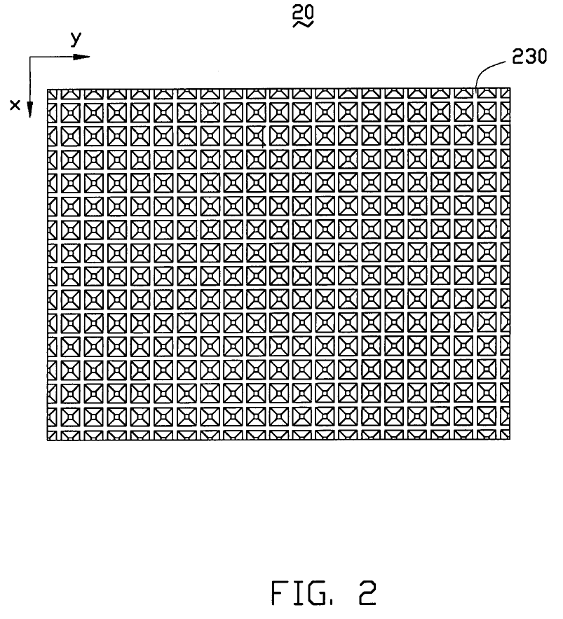

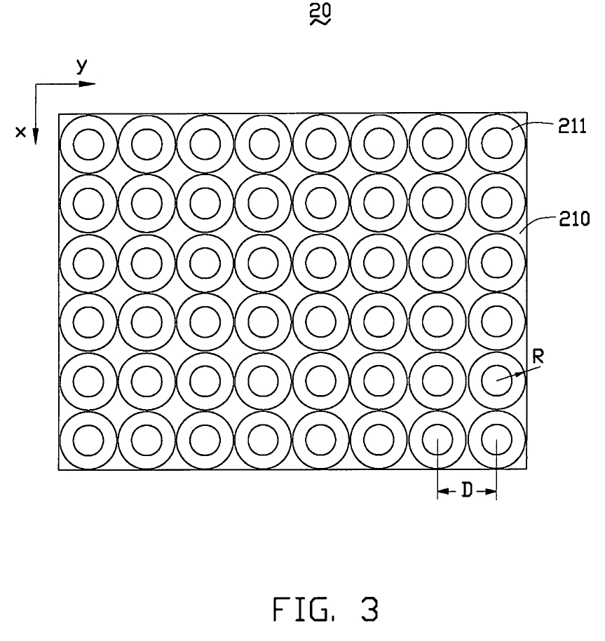

Referring to FIG. 1, an optical plate 20 according to a first embodiment is shown. The optical plate 20 includes a first transparent layer 21, a light diffusion layer 22, and a second transparent layer 23. The light diffusion layer 22 is between the first and second transparent layers 21, 23. The first transparent layer 21, the light diffusion layer 22, and the second transparent layer 23 are integrally formed as a single unified body. That is, the first transparent layer 21 and the light diffusion layer 22 are in immediate contact with each other at a first common interface, and the second transparent layer 23 and the light diffusion layer 22 are in immediate contact with each other at a second common interface. This kind of unified body can be made by multi-shot injection molding technology, such that few or no gaps exist at the respective common interfaces. Referring also to FIGS. 2 and 3, the first transparent layer 21 defines a plurality of conical frustum protrusions 211 at an outer surface 210 thereof that is farthest from the second transparent layer 23. The second transparent layer 23 defines a plurality of micro depressions 231 at an outer surface 230 thereof that is farthest from the first transparent layer 21. Each of the micro depressions 231 includes at least three side surfaces connected to each other. In the illustrated embodiment, each micro depression 231 includes four flat side surfaces connected to each other. A transverse (horizontal) width of each side surface increases along a direction away from the light diffusion layer 22. The micro depressions 231 are configured for collimating light rays emitting from the second transparent layer 23, thereby improving the brightness of light illumination.

A thickness of each of the first transparent layer 21, the light diffusion layer 22, and the second transparent layer 23 can be greater than or equal to 0.35 millimeters. In a preferred embodiment, a combined thickness of the first transparent layer 21, the light diffusion layer 22, and the second transparent layer 23 is in the range from about 1.05 millimeters to about 6 millimeters. Each of the first transparent layer 21 and the second transparent layer 23 is made of transparent matrix resin selected from the group consisting of polyacrylic acid (PAA), polycarbonate (PC), polystyrene (PS), polymethyl methacrylate (PMMA), methylmethacrylate and styrene copolymer (MS), and any suitable combination thereof. It should be pointed out that the materials of the first and second transparent layers 21, 23 can be the same material, or can be different materials.

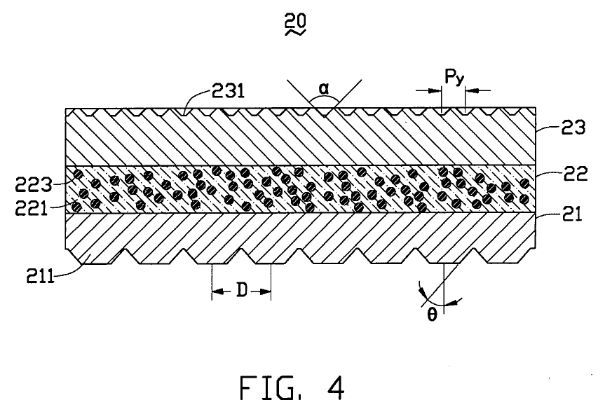

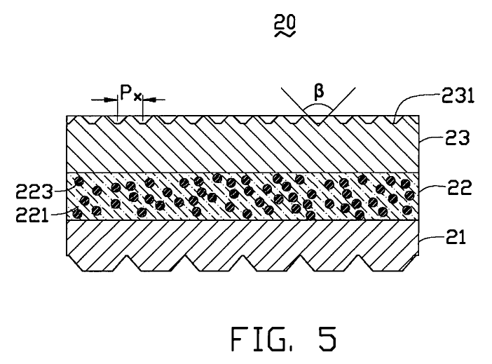

Further referring to FIGS. 4 and 5, the conical frustum protrusions 211 are formed at the outer surface 210 of the first transparent layer 21 in a matrix, and are separate from one another. A horizontal width of each conical frustum protrusion 211 decreases from a bottom of the conical frustum protrusion 211 to a top end of the conical frustum protrusion 211. The top ends of the conical frustum protrusions 211 are coplanar with the outer surface 210 of the first transparent layer 21. Thus a cross-section taken along a central (vertical) axis of symmetry of each conical frustum protrusion 211 defines an isosceles trapezoid. A pitch D between two adjacent conical frustum protrusions 211 is configured to be preferably in the range from about 0.025 millimeters to about 1.5 millimeters. A maximum radius R of the top end of each conical frustum protrusion 211 is configured to be in the following range: D/4≦R≦D/2. Accordingly, the maximum radius R is preferably in the range from about 6.25 microns to about 0.75 millimeters. An angle θ of an outer side surface of the conical frustum protrusion 211 with respect to the central axis of the conical frustum protrusion 211 is preferably in the range from about 30 degrees to about 75 degrees.

The micro depressions 231 are arranged regularly at the outer surface 230 in a matrix, and are separate from one another. Each of the micro depressions 231 is generally frusto-pyramidal. That is, each micro depression 231 is in the form of a frustum of a rectangular pyramid. Each micro depression 231 includes four side surfaces (not labeled), and an inmost (bottom) surface interconnecting the side surfaces. Each of the side surfaces of the micro depression 231 is an isosceles trapezoid. Pₓ represents a pitch between two adjacent micro depressions 231 aligned along an X-axis direction, as shown in FIGS. 1 and 5. P_{y} represents a pitch between two adjacent micro depressions 231 aligned along a Y-axis direction, as shown in FIGS. 1 and 4. Each of Pₓ and P_{y} is configured to be in the range from about 0.025 millimeters to about 1 millimeter. Pₓ and P_{y} can be equal to each other or different from each other. In the illustrated embodiment, Pₓ is equal to P_{y} Referring to FIG. 4, a dihedral angle α is defined by a first pair of opposite side surfaces of each micro depression 231 whose planes are parallel to the X-axis. Referring to FIG. 5, a dihedral angle β is defined by a second pair of opposite side surfaces of each micro depression 231 whose planes are parallel to the Y-axis. Each of the angles α and β is configured to be in the range from about 60 degrees to about 120 degrees. The angles α, β can be equal to each other or different from each other. In the illustrated embodiment, the angle α is equal to the angle β.

The light diffusion layer 22 includes a transparent matrix resin 221, and a plurality of diffusion particles 223 dispersed in the transparent matrix resin 221. In the illustrated embodiment, the diffusion particles 223 are substantially uniformly dispersed in the transparent matrix resin 221. The light diffusion layer 22 is configured for enhancing uniformity of light output from the optical plate 20. The transparent matrix resin 221 is preferably selected from the group consisting of polyacrylic acid (PAA), polycarbonate (PC), polystyrene (PS), polymethyl methacrylate (PMMA), methylmethacrylate and styrene copolymer (MS), and any suitable combination thereof. The diffusion particles 223 are preferably made of material selected from the group consisting of titanium dioxide, silicon dioxide, acrylic resin, and any combination thereof. The diffusion particles 223 are configured for scattering light rays and enhancing a light distribution capability of the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 223.

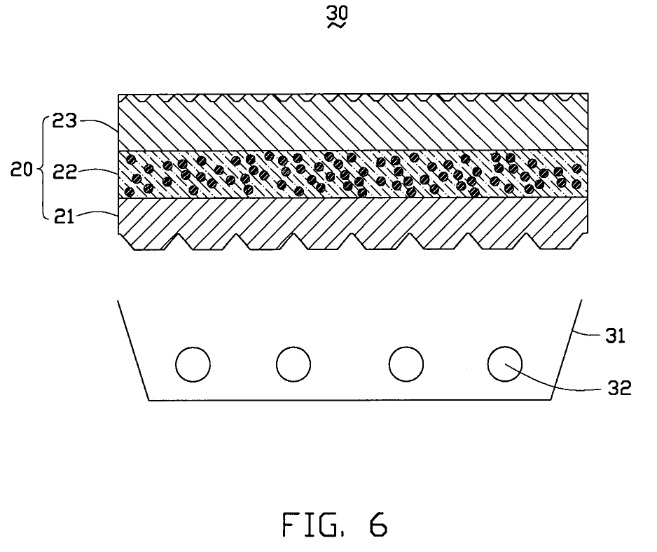

Referring to FIG. 6, a direct type backlight module 30 according to a second embodiment of the present invention is shown. The backlight module 30 includes a housing 31, a plurality of lamp tubes 32, and the optical plate 20. The lamp tubes 32 are regularly arranged above a base of the housing 31. The optical plate 20 is positioned on top of the housing 31, with the first transparent layer 21 facing the lamp tubes 32. It should be pointed out that in an alternative embodiment, the second transparent layer 23 of the optical plate 20 can be arranged to face the lamp tubes 32. That is, light rays from the lamp tubes 32 can enter the optical plate 20 via a selected one of the first transparent layer 21 and the second transparent layer 23.

In the backlight module 30, when the light rays enter the optical plate 20 via the first transparent layer 21, the light rays are diffused by the conical frustum protrusions 211 of the first transparent layer 21. Then the light rays are further substantially diffused in the light diffusion layer 22. Finally, many or most of the light rays are condensed by the micro depressions 231 of the second transparent layer 23 before they exit the optical plate 20. Therefore, a brightness of the backlight module 30 is increased. In addition, the light rays are diffused at two levels, so that a uniformity of light output from the optical plate 20 is enhanced. Furthermore, the first transparent layer 21, the light diffusion layer 22, and the second transparent layer 23 are integrally formed together (see above), with few or no air or gas pockets trapped in the respective common interfaces. Thus there is little or no back reflection at the common interfaces, and the efficiency of utilization of light rays is increased. Moreover, the optical plate 20 utilized in the backlight module 30 in effect replaces the conventional combination of a diffusion plate and a prism sheet. Thereby, a process of assembly of the backlight module 30 is simplified, and the efficiency of assembly is improved. Still further, in general, a volume occupied by the optical plate 20 is less than that occupied by the conventional combination of a diffusion plate and a prism sheet. Thereby, a volume of the backlight module 30 is reduced.

In the alternative embodiment, when the light rays enter the optical plate 20 via the second transparent layer 23, the uniformity of light output from the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle of the backlight module 30 is somewhat larger than that of the backlight module 30 when the light rays enter the optical plate 20 via the second transparent layer 23.

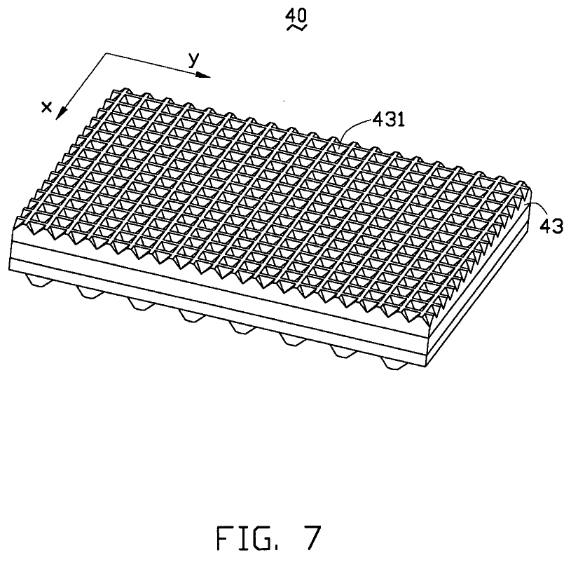

Referring to FIG. 7, an optical plate 40 according to a third embodiment is shown. The optical plate 40 is similar in principle to the optical plate 20 of the first embodiment, except that each of micro depressions 431 of a second transparent layer 43 is a four-sided pyramidal depression. That is, each of side surfaces of each micro depression 431 is an isosceles triangle. In the illustrated embodiment, each micro depression 431 is a square pyramidal depression.

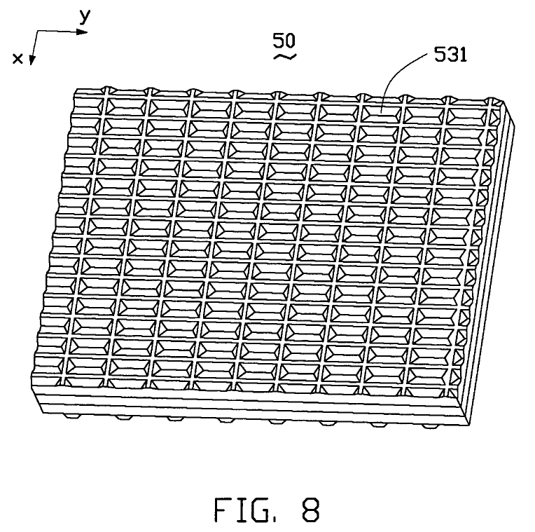

Referring to FIG. 8, an optical plate 50 according to a fourth embodiment is shown. The optical plate 50 is similar in principle to the optical plate 20 of the first embodiment. However, each of micro depressions 531 of the optical plate 50 is generally in the form of a polyhedron. In particular, each micro depression 531 has a four-sided pyramid-like configuration, which includes four side surfaces (not labeled). In the illustrated embodiment, the four side surfaces of each micro depression 531 include a pair of first opposite side surfaces parallel to an X-axis direction, and a pair of second opposite side surfaces parallel to a Y-axis direction. The first side surfaces are isosceles triangles, and the second side surfaces are isosceles trapezoids.

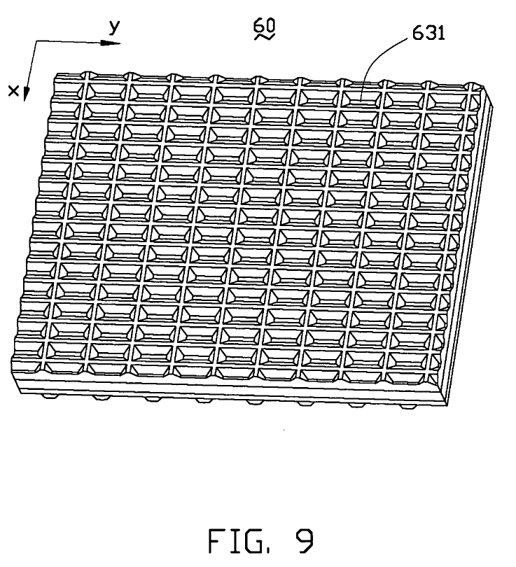

Referring to FIG. 9, an optical plate 60 according to a fifth embodiment is shown. The optical plate 60 is similar in principle to the optical plate 50 of the fourth embodiment. However, each of micro depressions 631 of the optical plate 60 is generally frusto-polyhedral. In particular, each micro depression 631 has a configuration of a frustum of a four-sided pyramid-like structure. The micro depression 631 includes four side surfaces (not labeled) and a bottom surface (not labeled). In the illustrated embodiment, each of the side surfaces of the micro depression 631 is an isosceles trapezoid, and the bottom surface is rectangular. An area of each of a pair of first opposite side surfaces that are parallel to a Y-axis is greater than an area of each of a pair of second opposite side surfaces that are parallel to an X-axis.

It should be noted that the scope of the present optical plate is not limited to the above-described embodiments. In particular, even though specific shapes of micro depressions have been described and illustrated, the micro depressions can have various other suitable shapes. For example, the micro depressions can be three-sided (triangular) pyramidal depressions, four-sided (rectangular) pyramidal depressions, five-sided (pentagonal) pyramidal depressions, multi-sided (polygonal) pyramidal depressions, or frustums of these.

In the above-described embodiments, the first common interface between the light diffusion layer and the first transparent layer is planar, and the second common interface between the light diffusion layer and the second transparent layer is also planar. Alternatively, either or both of the common interfaces can be nonplanar. For example, either or both of the common interfaces can be curved or wavy.

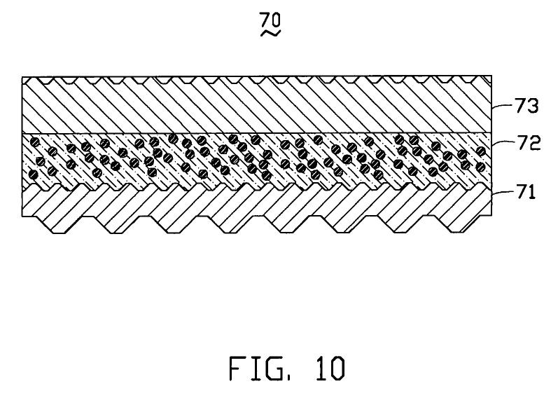

Referring to FIG. 10, an optical plate 70 according to a sixth embodiment is shown. The optical plate 70 is similar in principle to the optical plate 20 of the first embodiment. However, the optical plate 70 includes a first transparent layer 71, a light diffusion layer 72, and a second transparent layer 73. A common interface (not labeled) between the first transparent layer 71 and the light diffusion layer 72 is nonplanar. In the illustrated embodiment, the common interface is defined by a plurality of protrusions of the first transparent layer 71 interlocked in a corresponding plurality of depressions of the light diffusion layer 72. Therefore an area of mechanical engagement between the first transparent layer 71 and the light diffusion layer 72 is increased, and a strength of mechanical engagement between the first transparent layer 71 and the light diffusion layer 72 is correspondingly increased.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the light diffusion layer, the first transparent layer, and the second transparent layer are integrally formed, with the first transparent layer in immediate contact with the light diffusion layer, and the second transparent layer in immediate contact with the light diffusion layer, and the first transparent layer comprises a plurality of conical frustum protrusions at outer surface thereof that is farthest from the second transparent layer, the second transparent layer comprises a plurality of micro depressions at an outer surface thereof that is farthest from the first transparent layer, each micro depression has at least three side surfaces connected to each other, and a transverse width of each side surface increases along a direction away from the light diffusion layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer, and the second transparent layer is in the range from about 1.05 millimeters to about 6 millimeters.

4. The optical plate as claimed in claim 1, wherein each of the first transparent layer and the second transparent layer is made of material selected from the group consisting of polyacrylic acid, polycarbonate, methylmethacrylate and styrene copolymer, polystyrene, polymethyl methacrylate, and any combination thereof.

5. The optical plate as claimed in claim 1, wherein a pitch between two adjacent conical frustum protrusions is in the range from about 0.025 millimeters to about 1.5 millimeters.

6. The optical plate as claimed in claim 5, wherein a maximum radius of an inmost end of each conical frustum protrusion is in the range from about 6.25 microns to about 0.75 millimeters.

7. The optical plate as claimed in claim 6, wherein the micro depressions are arranged in a regular array at the outer surface of the second transparent layer, and are separate from one another.

8. The optical plate as claimed in claim 1, wherein the micro depressions are shaped in a form selected from the group consisting of four-sided pyramidal depressions, frustums of four-sided pyramidal depressions, four-sided pyramid-like depressions, and frustums of four-sided pyramid-like depressions.

9. The optical plate as claimed in claim 8, wherein for each four-sided pyramidal depression and each frustum of a four-sided pyramidal depression, a first pair of opposite sides defines a first dihedral angle, a second pair of opposite sides defines a second dihedral angle, and each of the first and second dihedral angles is in the range from about 60 degrees to about 120 degrees.

10. The optical plate as claimed in claim 8, wherein each of the frustums of four-sided depressions comprises four side surfaces, and each of the side surfaces is an isosceles trapezoid.

11. The optical plate as claimed in claim 8, wherein each of the four-sided pyramid-like depressions comprises four side surfaces, the four side surfaces comprise a pair of first opposite side surfaces parallel to a first direction, each of said pair of first opposite side surfaces being isosceles triangles, and a pair of second opposite side surfaces parallel to a second direction, each of said pair of second opposite side surfaces being isosceles trapezoids, and the first direction is perpendicular to the second direction.

12. The optical plate as claimed in claim 8, wherein each of the frustums of four-sided pyramid-like depressions comprises four side surfaces and an inmost surface, each of the side surfaces is an isosceles trapezoid, each of a pair of first opposite side surfaces is larger than each of a pair of second opposite side surfaces, and the inmost surface is rectangular.

13. The optical plate as claimed in claim 1, wherein at least one of the following interfaces is planar: an interface between the first transparent layer and the light diffusion layer, and an interface between the second transparent layer and the light diffusion layer.

14. The optical plate as claimed in claim 1, wherein at least one of the following interfaces is nonplanar: an interface between the light diffusion layer and the first transparent layer, and an interface between the light diffusion layer and the second transparent layer.

15. The optical plate as claimed in claim 14, wherein the interface between the light diffusion layer and the first transparent layer is defined by a plurality of protrusions of the first transparent layer interlocked in a corresponding plurality of depressions of the light diffusion layer.

16. The optical plate as claimed in claim 1, wherein a material of the transparent matrix resin of the light diffusion layer is selected from the group consisting of polyacrylic acid, polycarbonate, polystyrene, polymethyl methacrylate, methylmethacrylate and styrene copolymer, and any suitable combination thereof.

17. The optical plate as claimed in claim 1, wherein a material of the diffusion particles is selected from the group consisting of titanium dioxide, silicon dioxide, acrylic resin, and any combination thereof.

18. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed, with the first transparent layer in immediate contact with the light diffusion layer, and the second transparent layer in immediate contact with the light diffusion layer, and the first transparent layer defines a plurality of conical frustum protrusions at outer surface thereof that is farthest from the second transparent layer, the second transparent layer defines a plurality of micro depressions at an outer surface thereof that is farthest from the first transparent layer, each micro depression has at least three side surfaces connected to each other, and a transverse width of each side surface increases along a direction away from the light diffusion layer.

19. The direct type backlight module as claimed in claim 18, wherein a selected one of the first transparent layer and the second transparent layer of the optical plate is arranged to face the light sources.

20. An optical plate, comprising:
a first transparent layer;
a second transparent layer; and
a light diffusion layer between the first transparent layer and the second transparent layer, the light diffusion layer including a transparent matrix resin and a plurality of diffusion particles substantially uniformly distributed in the transparent matrix resin, wherein the first transparent layer, the light diffusion layer, and the second transparent layer are integrally formed, with the first transparent layer gaplessly in contact with the light diffusion layer, and the second transparent layer gaplessly in contact with the light diffusion layer, and the first transparent layer defines a plurality of conical frustum protrusions at outer surface thereof that is farthest from the second transparent layer, the second transparent layer defines a plurality of micro depressions at an outer surface thereof that is farthest from the first transparent layer, each micro depression has at least three side surfaces connected to each other, and a transverse width of each side surface increases along a direction away from the first transparent layer.
